(19) United States
(12) Patent Application Publication
(10) Pub. No.: US 2013/0205674 A1
(43) Pub. Date: Aug. 15, 2013

(54) BOX SECURITY COVER AND BOX

(71) Applicant: Michael James Damon, Reno, NV (US)

(72) Inventor: Michael James Damon, Reno, NV (US)

(73) Assignee: JENSEN ENTERPRISES, INC, dba JENSEN PRECAST, Sparks, NV (US)

(21) Appl. No.: 13/605,868

(22) Filed: Sep. 6, 2012

Related U.S. Application Data
(60) Provisional application No. 61/599,269, filed on Feb. 15, 2012.

(51) Int. Cl. E05C 19/00

(52) U.S. Cl. 49/465

(57) ABSTRACT

A box security cover comprising a box cover and a locking assembly. The box security cover can be positioned on a box, and the locking assembly can move between an unlocked position in which the security cover can be removed and a locked position in which braces of the locking assembly can contact interior surfaces of the box, preventing removal of the security cover from the box.

### CROSS-REFERENCE TO RELATED APPLICATIONS

This application is related to and claims priority to U.S. Provisional Application No. 61/599,269, filed Feb. 15, 2012, the entire application of which is hereby incorporated by reference and made a part of this specification.

### BACKGROUND

1. Field of the Disclosure

The present disclosure relates generally to covers for enclosures and, in particular, to security covers for subsurface access enclosures or boxes.

2. Description of the Related Art

Many varieties of box security covers exist, employing a variety of security and locking mechanisms. However, such devices and certain components thereof have various limitations and disadvantages.

### SUMMARY OF THE DISCLOSURE

A box security cover can be used to limit the ability of unauthorized individuals to access the contents of a box. Such boxes may include, but are not limited to, precast concrete or polymer boxes and boxes marked or unmarked for electric, high voltage, street lighting, traffic signal, ground, signal, communication, cable TV, low voltage, CCTV, water, water meters, etc. Such boxes can be cylindrical, rectangular, or of any shape. In some embodiments, a box can refer to a manhole. A security cover can, when locked, desirably prevent access to the box without special tools.

In some embodiments, a security assembly can include a cover and a guide frame attached to an interior surface of the cover. The guide frame can have a first end and a second end, and a first track and a second track extending between the first end and the second end. A first guide can connect the first track and second track at the first end, and a second guide can connect the first track and second track at the second end.

A first brace can be positioned between the first track and the second track at the first end, and the first guide can pass through the first brace. Either the first brace or the first and second track can have at least one first end slot positioned to receive the first guide such that the first brace can move relative to the first and second track. A second brace can be positioned between the first track and the second track at the second end, and the second guide can pass through the second brace. Either the second brace or the first and second track can have at least one second end slot positioned to receive the second guide such that the second brace can move relative to the first and second track.

The security assembly can also have a central cam with an opening configured to receive an actuator. The central cam can be positioned between the first and second braces and configured to move the braces from an unlocked position to a locked position as the actuator moves the cam. In some embodiments, the security assembly can have a spring that connects the first and second brace, biasing them toward the unlocked position.

In some embodiments, the security assembly can include a box with an opening, and the cover can be configured to seat on a surface of the box and block the opening. In some embodiments, the box can be a manhole and the cover can be circular. In some embodiments, the braces in the locked position can prevent removal of the cover by contacting an interior surface of the box. In some embodiments, at least a portion of the interior surface of the box can incline toward the center of the box.

In some embodiments, the security assembly can have at least one pick hole that passes through the cover. The pick hole can be positioned such that at least one of the braces blocks the pick hole when the braces are in the locked position.

In some embodiments, a security cover can include a cover with an interference portion configured to attach to a bottom surface of the cover such that it is movable in a direction substantially parallel to the bottom surface. A cam can be positioned against the interference portion and can move in a direction substantially transverse to the bottom surface. An actuator, accessible from a top side of the cover, can be configured to move the cam. When the cover is placed on a box, the actuator can selectively move the cam into a locked position in which the cam forces the interference portion into locking engagement with an interior surface of the box. In some embodiments, the box can be a manhole and the cover can be circular.

In some embodiments, the interior surface of the box can be angled relative to the direction of motion of the cam. In some embodiments, the cam can move toward the bottom surface of the cover as the cam moves into the locked position.

In some embodiments, the cover can have at least one pick hole and the cam in the locked position can force the interference portion into a position that blocks the pick hole. In some embodiments, the security cover can a second interference portion configured to attach to the bottom surface of the cover on an opposite side of the cam as the first interference portion. The second interference portion can be moveable in a direction substantially parallel to the bottom surface of the cover and can be configured to lockingly engage the interior surface of the box when the cam is in a locked position. In some embodiments, the security cover can include a spring connecting the first and second interference portions, biasing them away from locking engagement with the interior surface of the box.

### BRIEF DESCRIPTION OF THE DRAWINGS

FIG. 1 is a top perspective view of the top of a box security cover positioned on a box.

FIG. 2 is a cross-sectional view of one embodiment of a box security cover in an unlocked position.

FIG. 3 is a cross-sectional view of the embodiment of FIG. 2, but with the box security cover in a locked position.

FIG. 4 is a bottom perspective view of the box security cover of FIG. 1.

FIG. 5 is a bottom perspective view of one embodiment of a box security cover.

FIG. 6 is a bottom perspective view of the box security cover of FIG. 5.

FIG. 7 is a top perspective view of the top the box security cover of FIG. 5.

FIG. 8A is a top perspective view and partial cutaway of one embodiment of a box security cover for use on a manhole.

FIG. 8B is a view of the section 8B marked in FIG. 8A.

### DETAILED DESCRIPTION OF THE PREFERRED EMBODIMENT

With reference to the attached figures, certain embodiments and examples of box security covers will now be described.

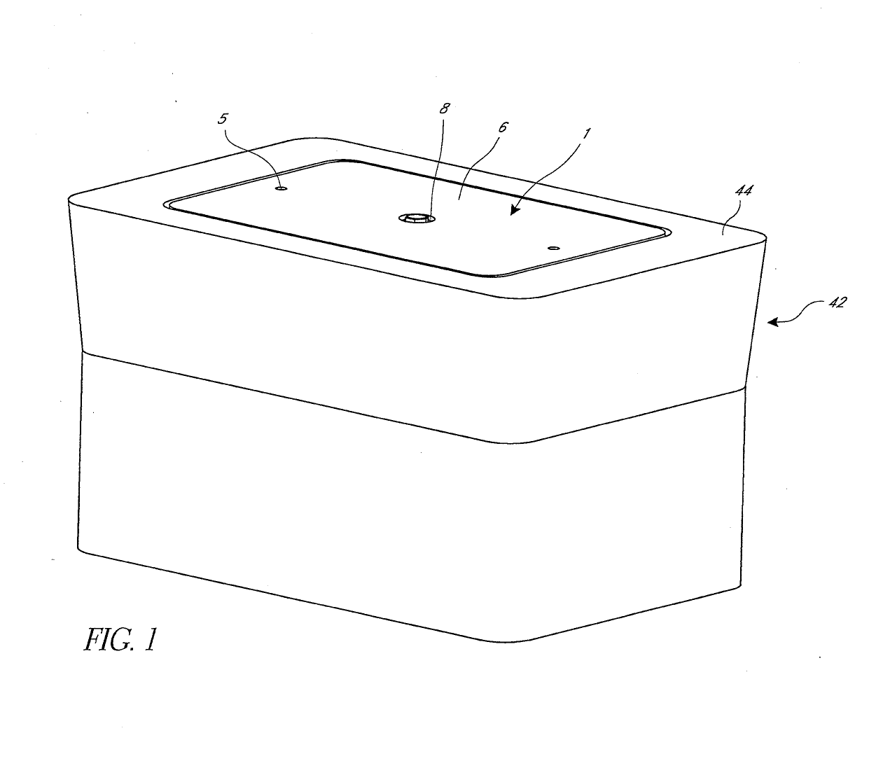

FIG. 1 illustrates a top perspective view of one embodiment of a box security cover 1. The box security cover desirably seats on a box 42. The security cover is desirably seated tightly and flush with the top surface of the box 44 in order to prevent unwanted removal of the cover by use of, for example, a crow bar.

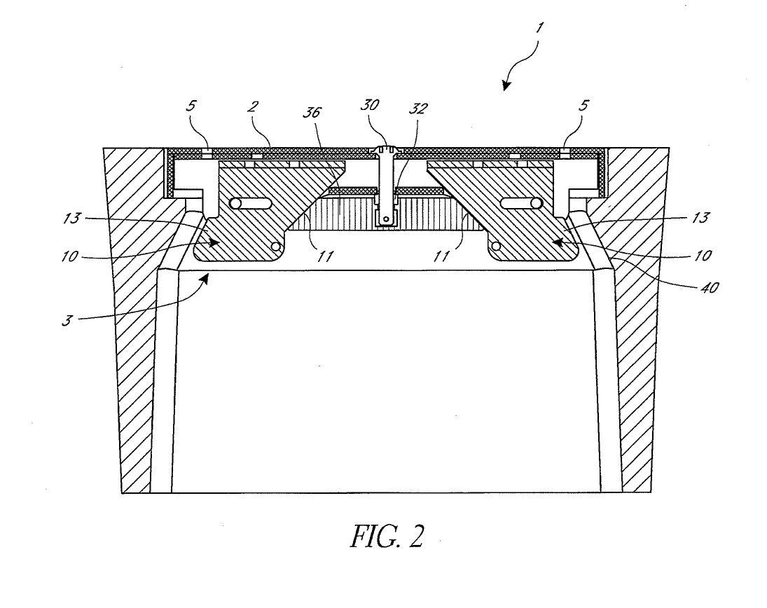

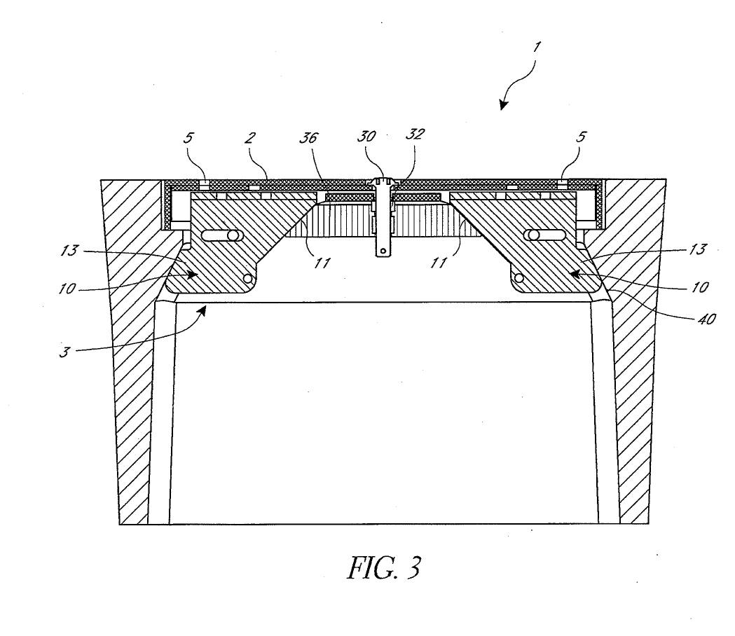

As illustrated in FIGS. 2 and 3, the box security cover desirably comprises a lid or box cover 2 and a locking assembly 3. In some embodiments, the locking assembly can attach to a box cover when the cover is manufactured. In some embodiments, the locking assembly can be used to retrofit an existing box cover.

The locking assembly desirably comprises at least two braces or interference portions 10 positioned on opposite sides of the box, although in some embodiments the locking assembly can comprise a single brace. Descriptions and embodiments herein that refer to braces can also refer to a single brace. The braces can move between an unlocked and a locked position, as described in more detail below. In the locked position, the braces can interact with interior surfaces 40 of the box to prevent or hinder removal of the security cover. In some embodiments, the box can be cylindrical or of other rounded shapes and the braces can be considered to interact with a single interior surface. In the unlocked position, the braces can be positioned such that the security cover can be removed from the box without the braces contacting the interior surfaces of the box and preventing removal.

FIG. 2 illustrates the braces 10 in an unlocked position in which they do not engage the interior surfaces 40 of the box. In this position, the security cover can be removed without significant resistance or any resistance from the braces. In some embodiments, the security cover has one or more pick holes 5, and the security cover can be removed by inserting a tool into a pick hole 5 and lifting the cover off of the box.

FIG. 3 illustrates the braces in a locked position, braced against the interior surface 40 of the box. In some embodiments, the braces 10 do not contact the interior surfaces 40 in the locked position, but are positioned close enough to the interior surfaces 40 such that they will contact the interior surfaces if the security cover is lifted. The braces can contact the interior surfaces of the box with sufficient pressure to make it substantially difficult to lift the box cover off of the box. Additionally, in some embodiments and as illustrated, while the braces 10 are in the locked position they can block the pick holes 5, making unwanted removal of the box cover even more difficult.

In some embodiments, such as the embodiment illustrated in FIG. 3, the interior surfaces 40 of the box can be inclined toward the middle of the box, further improving the security of the security cover. In some embodiments, the box can comprise a collar, ledge, or other interior projection which blocks the braces from moving upward when they are in the locked position, preventing removal of the security cover. In some embodiments, the braces can have projecting portions 13 along a lateral side of each brace that can contact the inclined interior surfaces 40 or that can be inserted beneath the collar or ledge when the box cover is in the locked position. In some embodiments, the projecting portions 13 can have a slanted edge that generally matches the angle of the interior surfaces 40, allowing for a greater contact area between the braces and the interior surfaces.

As illustrated in FIGS. 2 and 3, the braces desirably have one or more slanted surfaces 11 along a medial side of the brace. A cam 36 can be positioned such that a slanted surface of the cam contacts a slanted surface 11 of each brace. Where there are two braces, as illustrated, the cam can be located between the two braces. The cam is desirably positioned against a slanted surface 11 of the braces 10 such that movement of the cam toward the box cover 2 produces a component force against the braces 10, which pushes the braces toward the edge of the box and toward the locked position.

FIGS. 2 and 3 illustrate this motion. In FIG. 2, the braces 10 and cam 36 are in an unlocked position. In FIG. 3, the cam has moved up toward the box cover 2 and into a locked position, driving the braces in a horizontal direction (i.e. parallel to the box cover) and into a locked position in which the braces are braced against interior surfaces 40 of the box.

As illustrated, the cam 36 can comprise an actuator such as a collar 32 that receives a bolt 30. The collar and bolt can be threaded, such that tightening the bolt raises the cam, driving the braces toward the locked position and against the interior surfaces 40 of the box. In other embodiments, other mechanisms can drive the cam and braces into a locked position. For example, in some embodiments the cam and braces can be spring-driven into the locked position and a tool can be required to push the cam and braces into an unlocked position to remove the box cover. Additionally, in some embodiments a spring can he used to help pull the braces into the unlocked position from the locked position, as discussed in more detail below.

Returning to FIG. 1, the upper surface 6 of the box cover 2 is illustrated. The upper surface can comprise a recess 8 that can receive the bolt 30. The recess can be configured such that the bolt remains below or level with the upper surface 6. This desirably prevents the bolt from interfering with activity on the upper surface, and also makes it more difficult to access the bolt to unlock the security mechanism. Additionally, the bolt can be of a non-standard design, or can have other tamper-resistance features to make its removal by unauthorized individuals more difficult.

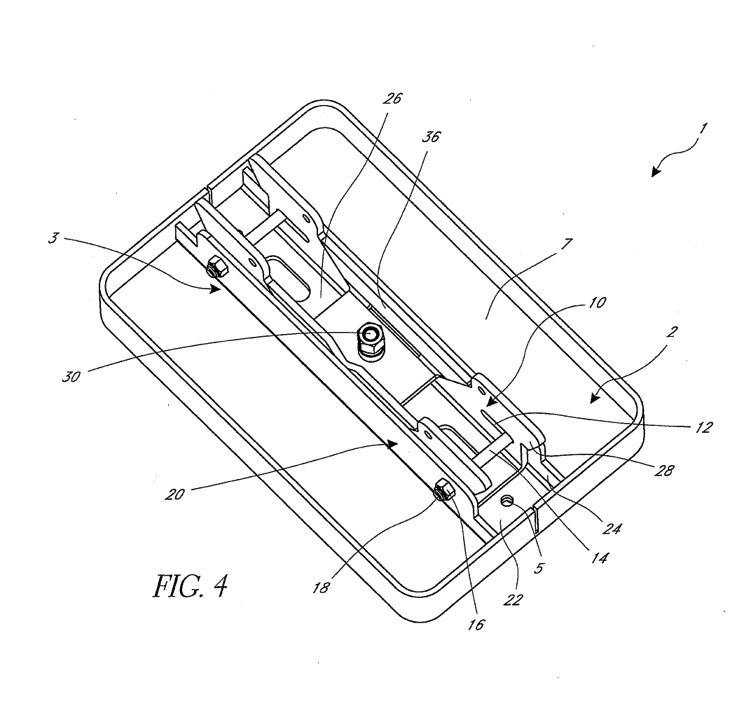

FIG. 4 is a view of one embodiment of a box security cover 1, illustrating the braces and a design that allows them to move between locked and unlocked positions. The locking assembly 3 desirably has a guide frame 20 that is attached to the box cover 2. The guide frame 20 can comprise a base surface 22 and two tracks (e.g. walls) 24. In some embodiments, the walls can be substantially parallel to each other. Holes through the base surface can align with holes through the cover 2 to form the pick holes 5. In some embodiments, the guide frame can comprise two substantially parallel walls without a base surface connecting them.

The walls 24 of the guide frame can be connected by guides (e.g. rods) 14. The rods desirably comprise a threaded portion 18 along their ends such that they can be secured to the walls with nuts 16. Other methods of securing the rods to the walls may be used. In the illustrated embodiment, the security cover comprises two rods, one positioned at either end of the guide frame, although more or fewer rods can be used.

At least two braces 10 are desirably positioned within the guide frame 20, although in some embodiments a single brace can be used. Each brace can comprise at least one slot 12, which can be configured to receive a rod 14. The braces can be a substantially solid piece or can comprise substantially parallel walls 28 that are joined by a base surface 26, as illustrated. The engagement between the slots 12 and rods 14 is desirably configured to allow the braces to slide along the length of the slot between their unlocked and locked positions. In some embodiments, instead of the walls 28 of the braces 10 having a slot, the walls 24 of the guide frame 20 can have a slot that allows the braces to slide between unlocked and locked positions. In these embodiments, the rods 14 can be fixedly attached to the braces 10.

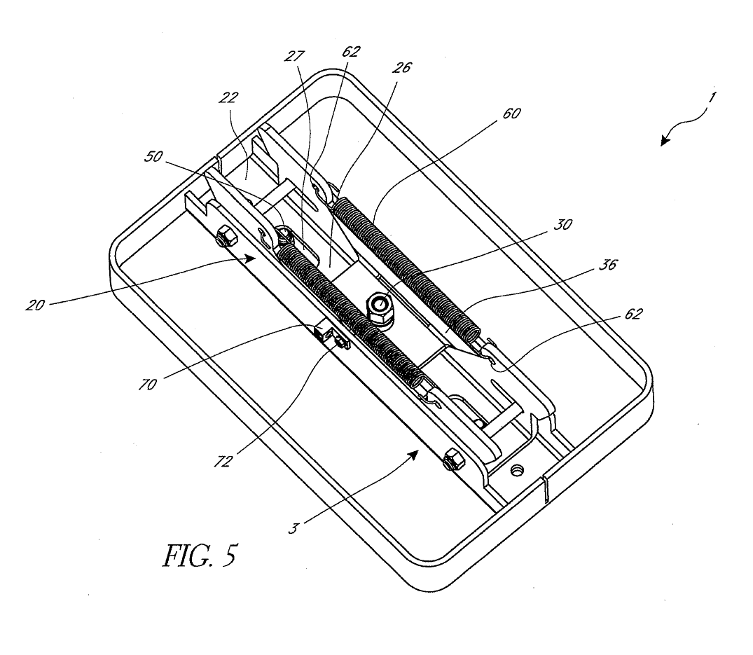

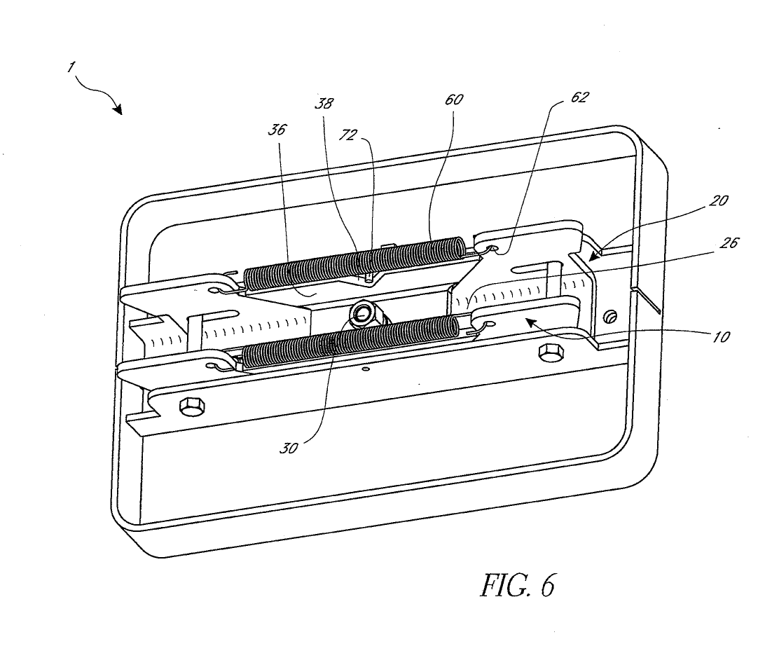

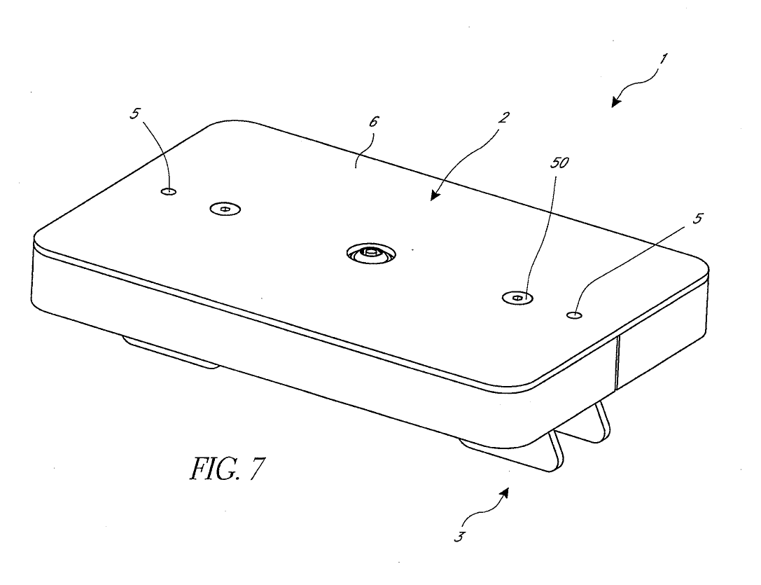

The locking assembly can attach to a box cover in a variety of ways. In the illustrated embodiments of FIGS. 1 through 4, the guide frame has been welded to the bottom surface 7 of the box cover 2. Among other attachment methods, the guide frame can also be bolted to the box cover, as illustrated in FIGS. 5 through 7. Attachment bolts 50 desirably secure to the base surface 22 of the guide frame 20. The base surfaces 26 of the braces 10 desirably have a slot 27 that can receive a bolt 50 and allow the brace to slide relative to the bolt. The attachment bolts are desirably either flush with or recessed into the upper surface 6 of the security cover 2, as illustrated in FIG. 7.

FIGS. 5 through 7 also illustrate the use of a spring or springs 60 to bias the braces 10 toward an unlocked position. This can help ensure that the braces return to an unlocked position when the cam 36 is moved into the unlocked position, leading to easier removal of the box security cover 1. The braces 10 can include holes or cutouts 62 to which the spring 60 can be attached. A spring can be used as part of any of the embodiments discussed herein.

In some embodiments, the locking assembly 3 can include a grounding lug 70 that can be used to ground the lid. The grounding lug 70 can be attached to the guide frame 20 or other component of the security cover 1 via a mounting element (e.g. a screw) 72. In some embodiments, the cam can include a notch 38 aligned with the mounting element 72.

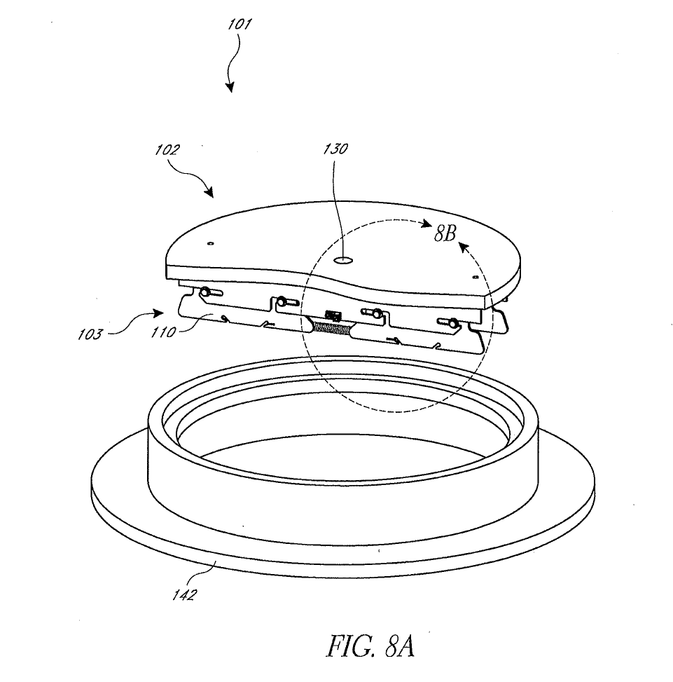

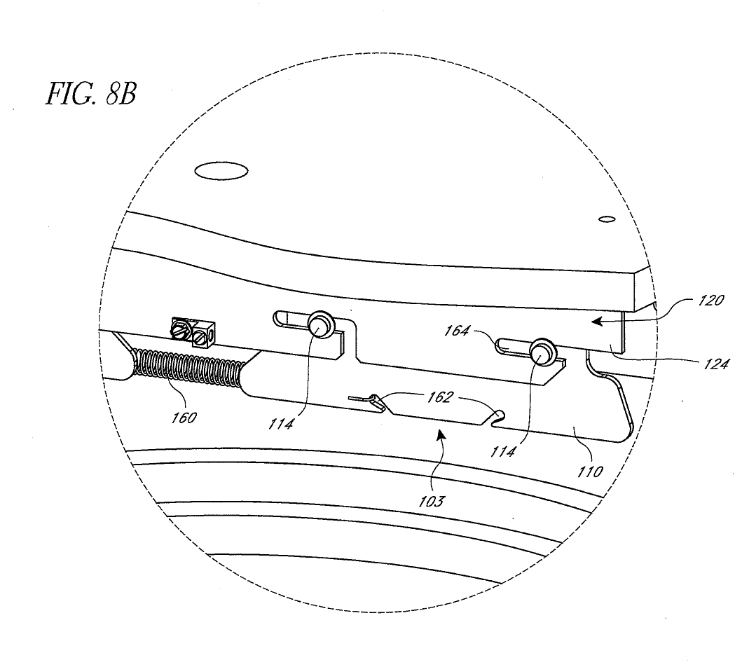

FIGS. 8A and 8B illustrate one embodiment of a box security cover 101 when used with a manhole 142. FIG. 8A is a top perspective view of the security cover 101 with a partial cutaway, positioned over the manhole 142. FIG. 8B is a zoomed view of the area marked in FIG. 8A.

As illustrated in FIG. 8A, and as above, the box security cover 101 desirably comprises a box cover 102 and a locking assembly 103. The box cover can be circular to fit within the manhole. FIG. 8B illustrates a more detailed view of the locking assembly 103. As discussed above, the locking assembly can include a spring 160, attached to cutouts 162, which can bias the braces toward an unlocked position.

FIG. 8B also illustrates an embodiment of a box security cover in which the braces 110 can each be attached to the walls 124 of the guide frame 120 with multiple rods 114. Additionally, FIG. 8B illustrates an embodiment where the walls of the guide frame 120 and not of the braces 110 have a slot or slots 164 in which the rods 114 can slide, allowing relative motion between the guide frame 120 and the braces 110.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A security assembly, the assembly comprising:
a cover and a guide frame attached to an interior surface of the cover, the guide frame comprising a first end, a second end, and a first track and a second track extending between the first end and the second end;
a first guide connecting the first track and second track at the first end, and a second guide connecting the first track and second track at the second end;
a first brace positioned between the first track and the second track at the first end, the first guide passing through the first brace, wherein the first brace or the first and second track comprise at least one first end slot positioned to receive the first guide such that the first brace can move relative to the first and second track;
a second brace positioned between the first track and the second track at the second end, the second guide passing through the second brace, wherein either the second brace or the first and second track comprise at least one second end slot positioned to receive the second guide such that the second brace can move relative to the first and second track; and
a central cam comprising an opening configured to receive an actuator, the central cam positioned between the first and second braces and configured to move the braces from an unlocked position to a locked position as the actuator moves the cam.

2. The security assembly of claim 1, further comprising a box with an opening, wherein the cover is configured to seat on a surface of the box and block the opening.

3. The security assembly of claim 2, wherein the box is a manhole and the cover is circular.

4. The security assembly of claim 2, wherein the braces in the locked position prevent removal of the cover from the box by contacting an interior surface of the box.

5. The security assembly of claim 4, wherein at least a portion of the interior surface of the box is inclined toward the center of the box.

6. The security assembly of claim 1, further comprising at least one pick hole that passes through the cover.

7. The security assembly of claim 6, wherein at least one of the braces blocks the at least one pick hole when the braces are in the locked position.

8. The security assembly of claim 1, further comprising a spring connecting the first and second brace, the spring configured to bias the braces toward the unlocked position.

9. A security cover, comprising:
a cover comprising an interference portion configured to attach to a bottom surface of the cover, the interference portion movable in a direction substantially parallel to the bottom surface;
a cam positioned against the interference portion and movable in a direction substantially transverse to the bottom surface; and
an actuator accessible from a top side of the cover and configured to move the cam;
wherein when the cover is placed on a box, the actuator is configured to selectively move the cam into a locked position in which the cam forces the interference portion into locking engagement with an interior surface of the box.

10. The security cover of claim 9, wherein the cover comprises at least one pick hole and the cam in the locked position forces the interference portion into a position that blocks the pick hole.

11. The security cover of claim 9, wherein the interior surface of the box is angled relative to the direction of motion of the cam.

12. The security cover of claim 9, wherein the cam moves toward the bottom surface of the cover as the cam moves into the locked position.

13. The security cover of claim 9, wherein the box is a manhole and the cover is circular.

14. The security cover of claim 9, further comprising a second interference portion configured to attach to the bottom surface of the cover on an opposite side of the cam as the first interference portion, the second interference portion moveable in a direction substantially parallel to the bottom surface of the cover and configured to lockingly engage the interior surface of the box when the cam is in a locked position.

15. The security cover of claim 14, further comprising a spring connecting the first and second interference portion, the spring configured to bias the interference portions away from locking engagement with the interior surface of the box.
